(19) United States
(12) Patent Application Publication
(10) Pub. No.: US 2010/0201044 A1
(43) Pub. Date: Aug. 12, 2010

(54) Production of a Parabolic Curved Mirror

(76) Inventor: Yagil Eran, Shoham (IL)

Correspondence Address: The Law Office of Michael E. Kondoudis, 888 16th Street, N.W., Suite 800, Washington, DC, 20006, US

(21) Appl. No.: 12/367,715

(22) Filed: Feb. 9, 2009

(51) Int. Cl. B29C 53/04

(52) U.S. Cl. 264/510; 425/111

(57) ABSTRACT

A system and method of producing a parabolic curved mirror are provided. The method includes: placing a plane mirror having a front surface and a back surface on a parabolic shaped form, such that the front surface of the plane mirror is facing the parabolic shaped form; pressing the plane mirror onto the parabolic shaped form, resulting in the parabolic curved mirror; and fixing the parabolic curved mirror by applying an adhesive to the back surface of the parabolic curved mirror.

### BACKGROUND

1. Technical Field

The present invention relates to the field of mirror production, and more particularly, to production of parabolic mirrors.

2. Discussion of the Related Art

Parabolic mirrors are used to concentrate sun light at the focal point for heating fluids and thus utilizing solar energy. A typical sun farm constitutes numerous parabolic mirrors, continuously directed at the sun and arranged to concentrate the reflected sun light onto the heat absorbing fluids. An efficient concentration of the sun light depends on the parabolic form of the mirrors, yet current production methods result in insufficient form correspondence and deviations from the optimal parabolic form.

### BRIEF SUMMARY

Embodiments of the present invention provide an apparatus for producing a parabolic curved mirror from a plane mirror having a front surface and a back surface. The apparatus comprises a parabolic shaped form upon which the plane mirror is placed with its front surface facing the parabolic shaped form. The apparatus is arranged to enable pressing the plane mirror against the parabolic shaped form, resulting in the parabolic curved mirror. The apparatus is further arranged to enable fixing the parabolic curved mirror in its form utilizing an adhesive.

Accordingly, according to an aspect of the present invention, there is provided an apparatus further comprising a base plate, a chamber containing the parabolic shaped form and the base plate, and an injecting device containing expanding material. The plane mirror is placed within the chamber, between the parabolic shaped form and the base plate, facing the parabolic shaped form, such that a space is created between the back surface of the plane mirror and the base plate. The injecting device is arranged to release the expanding material into the space between the plane mirror and the base plate, such that the pressure applied by the expanding material onto the back surface of the plane mirror presses the plane mirror onto the parabolic shaped form. The chamber is arranged to contain and control the expansion of the expanding material. The base plate is arranged to limit the expansion of expanding material, such that a predefined pressure is applied to plane mirror, resulting in the parabolic curved mirror.

Accordingly, according to another aspect of the present invention, there is provided an apparatus, wherein the expanding material comprises the adhesive.

Embodiments of the present invention provide a method of producing a parabolic curved mirror. The method comprises the stages: placing a plane mirror having a front surface and a back surface on a parabolic shaped form, such that the front surface of the plane mirror is facing the parabolic shaped form; pressing the plane mirror onto the parabolic shaped form, resulting in the parabolic curved mirror; and fixing the parabolic curved mirror by applying an adhesive to the back surface of the parabolic curved mirror.

Accordingly, according to an aspect of the present invention, there is provided a method that further comprises releasing an expanding material between the back surface of the plane mirror and a base plate, such that the expanding material exerts a force to the back surface of the plane mirror resulting in said pressing the plane mirror onto the parabolic shaped form.

Accordingly, according to another aspect of the present invention, there is provided a method, wherein the expanding material comprises the adhesive.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1A and 1B are high level schematic illustrations of an apparatus for producing parabolic curved mirrors, according to some embodiments of the invention;

FIGS. 2A and 2B are high level schematic illustrations of an apparatus for producing parabolic curved mirrors, according to some embodiments of the invention;

FIG. 3 is a high level flowchart illustrating a method of producing a parabolic curved mirror, according to some embodiments of the invention; and

FIG. 4 is a high level flowchart illustrating a method of producing a parabolic curved mirror, according to some embodiments of the invention.

The drawings together with the following detailed description make apparent to those skilled in the art how the invention may be embodied in practice.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

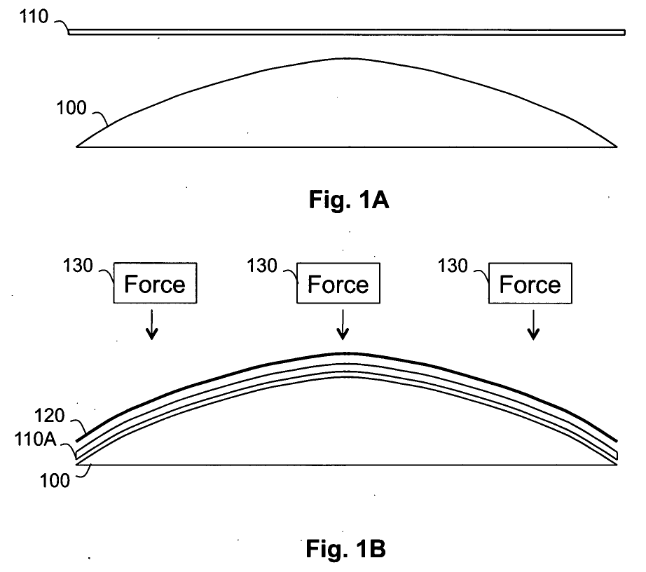

FIGS. 1A and 1B are high level schematic illustrations of an apparatus for producing parabolic curved mirrors, according to some embodiments of the invention. The apparatus comprises a parabolic shaped form 100 upon which a plane mirror 110 is placed with its front surface (i.e., the reflective surface) facing parabolic shaped form 100 (FIG. 1A). Plane mirror 110 is then pressed onto parabolic shaped form 100 by force 130 (FIG. 1B), applied to the back surface of plane mirror 110. The resulting curved mirror 110A (FIG. 1B) is then fixed in its form by an adhesive 120, e.g., an epoxy resin. Gaps in FIGS. 1A and 1B between parabolic shaped form 100 and curved mirror 110A, and between curved mirror 110A and adhesive 120 are depicted only for the illustration's clarity purposes. Plane mirror 110 is pressed against parabolic shaped form 100 and adhesive 120 fixes curved mirror 110A so that actual gaps are scant to non-existent.

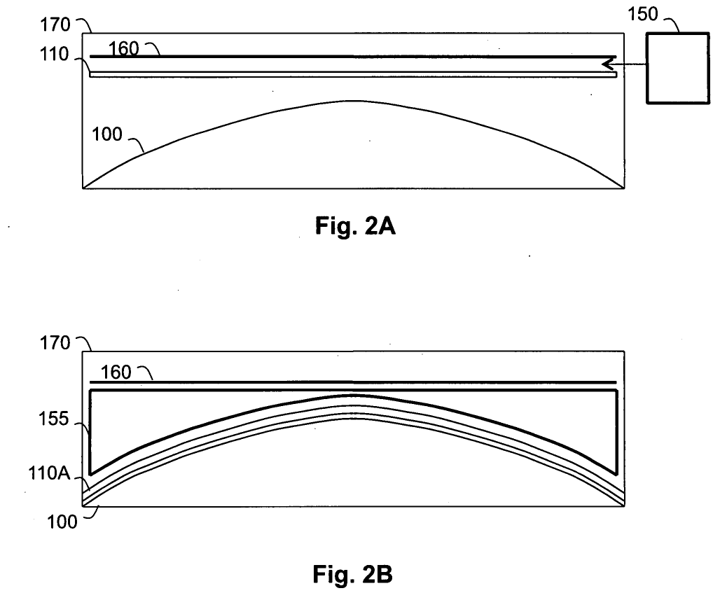

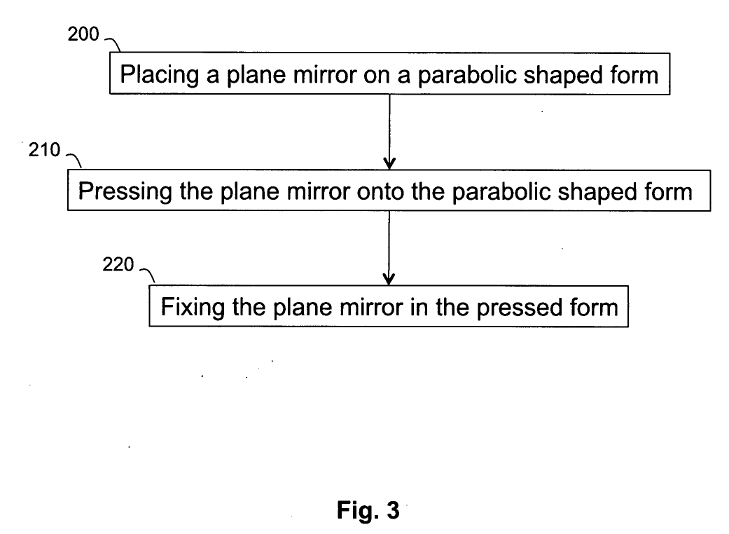

FIGS. 2A and 2B are high level schematic illustrations of an apparatus for producing parabolic curved mirrors, according to some embodiments of the invention. The apparatus comprises a parabolic shaped form 100, a base plate 160, a chamber 170 containing parabolic shaped form 100 and base plate 160, and an injecting device 150. The apparatus is arranged to enable placing a plane mirror 110 upon parabolic shaped form 100 within chamber 170 such that plane mirror 110's front surface faces parabolic shaped form 100. The apparatus is arranged such that base plate 160 is on the back side of plane mirror 110 (FIG. 1A). Injecting device 150 is arranged to release expanding material 155 into the space between base plate 160 and plane mirror 110, such that the pressure applied by expanding material 155 onto the back side of plane mirror 110 presses plane mirror 110 onto parabolic shaped form 100 (FIG. 2B). Chamber 170 is arranged to contain and control the expansion process. Base plate 160 is arranged to limit the expansion of expanding material 155 such that predefined pressure is applied to plane mirror 110. Plane mirror 110 is thus pressed onto parabolic shaped form 100 resulting in its changing its form to become a curved mirror 110A (FIG. 1B). Curved mirror 110A is fixed in its form expanding material 155 which is allowed to harden in place between curved mirror 110A and base plate 160. An example for such a hardening expanding material 155 is polyurethane, yet expanding material 155 may comprise any hardening foam as well. Alternatively, an adhesive may be applied to fix curved mirror 110A after expanding material 155 has pressed it to its form. Spaces between parabolic shaped form 100, curved mirror 110A and adhesive 120 are left solely for the clarity of the illustration.

According to some embodiments of the invention, parabolic shaped form 100 may comprise a convex base with a predefined radius, and chamber 170 may comprise convex base with a predefined radius, side walls of a predefined height and a sealable horizontal cover. Base plate 160 may comprise a rigid surface.

FIG. 3 is a high level flowchart illustrating a method of producing a parabolic curved mirror, according to some embodiments of the invention. The method comprises the stages of: placing a plane mirror on a parabolic shaped form (stage 200); pressing the plane mirror onto the parabolic shaped form (stage 210) with the plane mirror's front surface facing the parabolic shaped form; and fixing the plane mirror in the pressed form (stage 220). The method results in the production of a parabolic curved mirror.

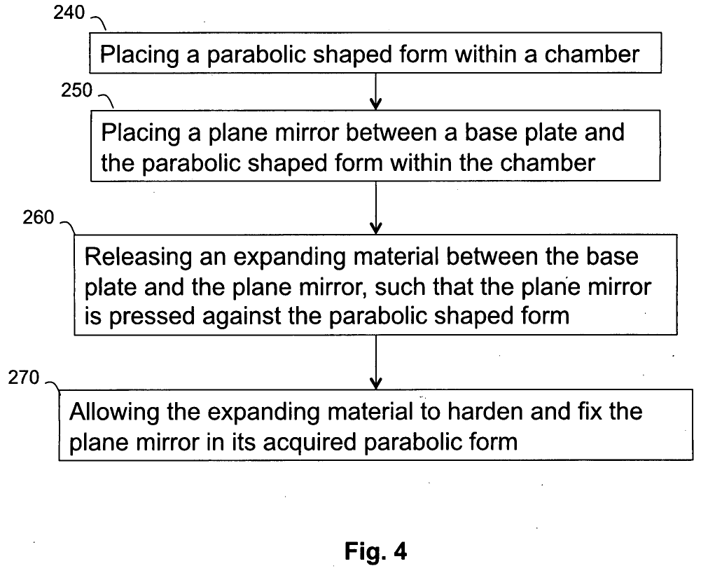

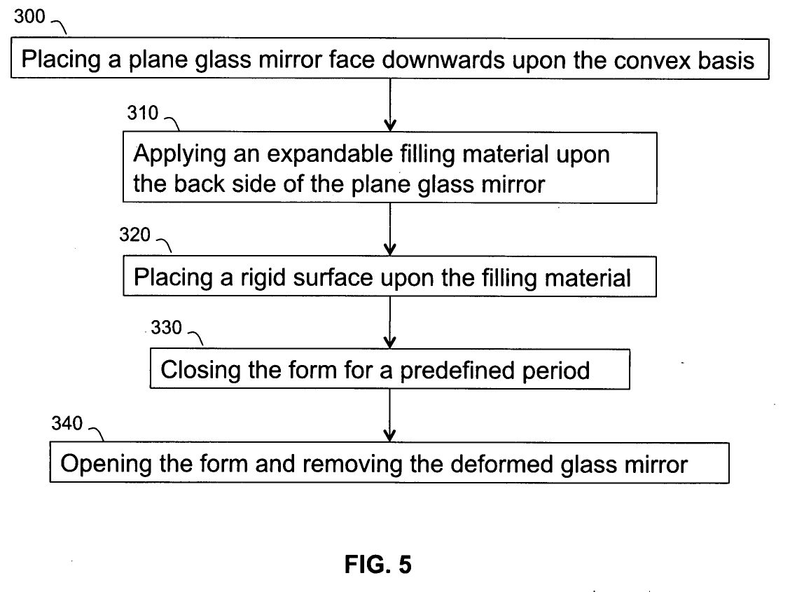

FIG. 4 is a high level flowchart illustrating a method of producing a parabolic curved mirror, according to some embodiments of the invention. The method comprises the stages of: placing a parabolic shaped form within a chamber (stage 240); placing a plane mirror between a base plate and the parabolic shaped form within the chamber (stage 250); releasing an expanding material between the base plate and the plane mirror (stage 260), such that the plane mirror is pressed against the parabolic shaped form; and allowing the expanding material to harden and fix the plane mirror in its acquired form (stage 270).

The chamber is constructed such as to support the parabolic shaped form, the base plate and the mirror, as well as to enable a controlled release of the expanding material and an appropriate removal of the curved mirror at the end of the method.

FIG. 5 is a high level flowchart illustrating a method of producing a curved glass mirror, according to some embodiments of the invention. The method utilizes a form having a convex base with a predefined radius, side walls of a predefined height and a sealable horizontal cover. The method comprises the stages of: placing a plane glass mirror face downwards upon the convex basis (stage 300); applying an expandable filling material upon the back side of the plane glass mirror (stage 310); placing a rigid surface upon the filling material (stage 320); closing the form for a predefined period (stage 330), such that the expandable filling material is allowed to expand to a predefined extent and thereby apply an expansion pressure upon the plane glass mirror causing its deformation and subsequently harden; and opening the form and removing the deformed glass mirror (stage 340). The deformed glass mirror is deformed concavely, fitting the form of the convex base, and thereupon fixed by the hardened expandable filling material.

According to some embodiments of the invention, the expandable filling material may comprise any expanding material, e.g., a foam, that may be mixed with a hardening material, e.g., a glue. The expandable filling material may comprise polyurethane or another polymer, that takes the volume between the glass mirror and the rigid surface and applies pressure in the order of magnitude of several kilograms per square centimeter. The pressure presses the glass mirror onto the convex basis and causes its concave deformation to fit the form of the convex basis. The hardening of expandable filling material fixes the glass mirror to generate a curved glass mirror of exact curvature, high strength and low fracture sensitivity.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An apparatus for producing a parabolic curved mirror from a plane mirror having a front surface and a back surface, the apparatus comprising:
a parabolic shaped form upon which the plane mirror is placed with its front surface facing the parabolic shaped form;
a base plate;
a chamber containing the parabolic shaped form and the base plate; and
an injecting device containing expanding material,
wherein the apparatus is arranged to enable pressing the plane mirror against the parabolic shaped form, resulting in the parabolic curved mirror,
wherein the apparatus is arranged to enable fixing the parabolic curved mirror in its form utilizing an adhesive,
wherein the plane mirror is placed within the chamber, between the parabolic shaped form and the base plate, facing the parabolic shaped form, such that a space is created between the back surface of the plane mirror and the base plate,
wherein the injecting device is arranged to release the expanding material into the space between the plane mirror and the base plate, such that the pressure applied by the expanding material onto the back surface of the plane mirror presses the plane mirror onto the parabolic shaped form,
wherein the chamber is arranged to contain and control the expansion of the expanding material, and
wherein the base plate is arranged to limit the expansion of expanding material, such that a predefined pressure is applied to plane mirror, resulting in the parabolic curved mirror.

2. The apparatus of claim 1, wherein the expanding material comprises the adhesive.

3. A method of producing a parabolic curved mirror comprising:
placing a plane mirror having a front surface and a back surface on a parabolic shaped form, such that the front surface of the plane mirror is facing the parabolic shaped form;
pressing the plane mirror onto the parabolic shaped form, resulting in the parabolic curved mirror; and
fixing the parabolic curved mirror by applying an adhesive to the back surface of the parabolic curved mirror.

4. The method of claim 3, further comprising:
releasing an expanding material between the back surface of the plane mirror and a base plate, such that the expanding material exerts a force to the back surface of the plane mirror resulting in said pressing the plane mirror onto the parabolic shaped form.

5. The method of claim 4, wherein the expanding material comprises the adhesive.

6. A method of producing a curved glass mirror utilizing a form having a convex base with a predefined radius, side walls of a predefined height and a sealable horizontal cover, the method comprising:
placing a plane glass mirror face downwards upon the convex basis;
applying an expandable filling material upon the back side of the plane glass mirror;
placing a rigid surface upon the filling material;
closing the form for a predefined period, such that the expandable filling material is allowed to expand to a predefined extent and thereby apply an expansion pressure upon the plane glass mirror causing its deformation and consequentially harden; and
opening the form and removing the deformed glass mirror,
wherein the deformed glass mirror is deformed concavely, fitting the form of the convex base, and thereupon fixed by the hardened expandable filling material.
